(19) United States
(12) Patent Application Publication
(10) Pub. No.: US 2015/0356814 A1
(43) Pub. Date: Dec. 10, 2015

(54) Method, System, and Device for Displaying the Outcome of a Wagering Game

(71) Applicants: Steven Wright, Huntington Beach, CA (US); Kyle Dennis Morris, Huntington Beach, CA (US)

(72) Inventors: Steven Wright, Huntington Beach, CA (US); Kyle Dennis Morris, Huntington Beach, CA (US)

(21) Appl. No.: 14/300,263

(22) Filed: Jun. 10, 2014

(51) Int. Cl. G07F 17/32; G07F 17/34

(52) U.S. Cl. CPC G07F 17/3213; G07F 17/34

(57) ABSTRACT

A method, system and device for displaying a game outcome without altering the game outcome disclosed. A gaming device conducts a wagering game. If game outcome is a Winning game outcome, the game outcome is displayed. If the game outcome fails to partially match a winning game outcome, the game outcome is likewise displayed. If the game outcome partially matches a winning game outcome, the game outcome is reordered prior to display by displaying the subset of the game outcome that matches a partial winning game outcome, then displaying the remainder of the game outcome separated from the partial winning outcome.

### FIELD OF THE INVENTION

The present invention relates to wagering games. More specifically, the present invention includes a method, system, and device for reordering a game outcome that partially matches a winning game outcome, without altering the game outcome.

### BACKGROUND OF THE INVENTION

Electronic gaming machines take many different forms and may be configured to conduct any type of game. For example, slot machines include a reel symbol set. A wager is received, typically in the form of coins, bills, vouchers, or the like, which initiates the game. Although slot machines may take the form of either electro-mechanical slot machines which use physical reels or video slot machines which use video displays to simulate physical reels, most slot machines use the same principle of operation.

Specifically, the reels include reel symbols displayed on their surfaces. A game outcome is determined by a random number generator working in cooperation with a data processor which controls physical reels or a video display of reels to spin and stop to display the game outcome. The payout for the game outcome is determined by comparing the symbols and/or symbol combinations lying along predefined pay lines. Games may include multiple pay lines, with the reel symbol combinations lying along each pay line being independently evaluated. For example, in a typical five reel game, three, four, or five adjacent matching symbols lying along a pay line may result in a payout. Frequently, the amount of the payout varies depending on the specific symbol and the quantity of matching symbols. For example, three single-bar symbols may pay result in a payout that is less than the payout for four single-bar symbols or three triple-bar symbols.

Video reel games utilize computer-generated representations of the reels and reel symbols. In a typical video reel game, a game outcome is determined based on one or more numbers randomly selected by a random number generator. The data processor then generates or selects an animation to display symbols on a pay line to correspond to the randomly determined game outcome. Wagers are resolved based on the randomly selected game outcome by issuing a payout corresponding to the combinations of reel symbols displayed on pay lines.

In both electro-mechanical slot machines and video slot machines, the player often is allowed to adjust the quantity of pay lines wagered upon. As discussed above, the outcome of a reel slot game is typically determined by the combination of reel symbols falling along predefined pay lines or the quantity of scatter symbols which may fall anywhere in the displayed areas of the reels. Thus, by increasing the quantity of active pay lines, a perception is created that greater winning opportunities exist, i.e., the probability that a winning combination of reel symbols will fall along a pay line is perceived to increase when a greater quantity of pay lines is activated. Typically, a wager is required to place an additional wager for each pay line activated. Thus, in a typical reel slot game, activating forty pay lines requires a greater wager than activating one pay line, assuming the amount wagered on each pay line is equal. In this regard, a typical reel slot game also permits a player to adjust the quantity wagered on each pay line. Typically, greater payouts are issued in association with greater wagers. Thus, in placing a wager, a player often adjusts two components of his or her wager—the quantity of pay lines wagered and the amount wagered on each pay line—with the quantity of pay lines perceived to alter the quantity of winning opportunities and the amount wagered on each pay line perceived to alter the payout amount for winning opportunities.

In a typical reel slot game, a player places a wager to initiate play of a slot machine. Greater wagers, or multiple wagers, may be required to, as described previously, increase the number of active pay lines and/or increase the wager per pay line. An outcome is generated by a random number generator and the outcome is displayed on the reels by mechanically spinning the reels, or animating “spinning” reels, and arresting the reels, or video simulations thereof. Payouts are defined by a pay table and determined based on the combinations of reel symbols displayed, with certain symbol combinations dependent on the location of the symbols with respect to pay lines and other “scatter” symbol combinations independent of pay lines. Payouts associated with each winning symbol combinations are typically issued as a multiple of the wager on the pay line on which the combination appeared.

Another video gaming device commonly found in the gambling industry conducts video card games, such as video poker, video blackjack, or the like. In the conventional game of video poker known in the art, receipt of a wager prompts a data processor to select at least one number via a random number generator. An initial hand of five playing cards is displayed which correspond to the random number(s).

Input is received from the player to select which, if any, of the five cards of the initial hand to hold. After selecting the held playing cards from the initial hand, the data processor (optionally in response to a prompt from the player) discards the remaining playing cards. The data processor again generates at least one number via a random number generator to determine playing cards to replace the discarded playing cards. The replacement playing cards along with the held cards form a final hand.

The data processor compares the final hand to a pay table which includes winning hands and associated payouts. Typically, the winning hands represent conventional ranked poker hands such as a pair of Jacks or better, two pair, three of a kind, and so forth. If the player's final hand matches a winning hand, the payout associated the final hand is issued. If the player's final hand does not match a winning hand, the player's wager is retained by the gaming device.

Yet another type of game typically found on gaming. devices is keno. Keno uses eighty numbers, typically the numbers one through eighty. In keno, players place a wager and mark the player's desired numbers on an electronic keno ticket, which is typically displayed as a grid of numbers on the gaming device. After the keno ticket is completed, twenty numbers are drawn by the gaming device. If the drawn numbers match a predetermined percentage of player-selected numbers, a payout is issued by the gaining device. Typically, the payout is determined by the quantity of matches.

Wagers in Keno can be generally divided into two groups, spot and way. Spot wagers consist of the player merely selecting individual numbers, or spots, on a keno ticket. If a player catches a predetermined number of spots, the player is rewarded. For example, on a ten-spot keno ticket, the player selects and marks ten numbers. A payout is issued if the player catches five or more spots. Typically, the reward increases with the number of spots the player catches. For example, if the player catches five spots, the player may receive his wager back; if the player catches ten spots, the player may be paid at ten thousand to one.

Way wagers consist of a player selecting groups of adjacent numbers, or ways, on a keno ticket. If a player catches a predetermined number of spots, the player is rewarded. Unlike spot wagers, however, the reward in a way wager depends on how the spots the player catches are distributed. For example, on a hi-low way keno ticket, the player selects and marks three groups of four adjacent numbers. If a player catches five or more spots, the player is rewarded. However, the size of the reward depends on the distribution of the spots. For example, if the spots are distributed with two in one way, two in another way, and one in yet another way (2-2-1), the player's wager is returned. Alternatively, if the spots are distributed 3-1-1, the player may be paid at 1.2:1; if the spots are distributed 4-1, the player may be rewarded at 1.4:1.

### SUMMARY OF THE INVENTION

The present invention includes methods and gaming devices for displaying the results of a wagering game. In one optional embodiment, a method is directed for a device having a data processor, a display in communication with the data processor, and a data storage device in communication with the data processor. In one such optional embodiment, the data storage device stores program instructions executable by the data processor to conduct the wagering game to generate a game outcome including a plurality of game elements, a schedule of winning game outcomes, and program instructions executable by the data processor to conduct a method according to the present invention. The game elements may take any form, including slot reel symbols, playing cards, numbers (such as keno or bingo numbers), or the like.

For example, in an optional embodiment, a wager is received and the wagering game is conducted to generate a game outcome. The game outcome is compared to the schedule of winning game outcomes by the data processor.

If the game outcome matches at least one of the winning game outcomes, the game outcome is displayed at the display when the game outcome matches. In an optional embodiment, a payout is issued by the data processor based on the schedule of winning game outcomes when the game outcome matches at least one of the winning game outcomes.

Conversely, if the game outcome does not match at least one of the winning game outcomes, the game outcome is reordered prior to being displayed. In one such optional embodiment, the wager is collected When the game outcome does not match at least one of the winning game outcomes.

In one optional embodiment, the reordering includes the data processor determining whether a subset of the game elements within the game outcome partially matches at least one of the winning game outcomes. The display of the game elements of the matching subset is separate from the display of the remaining game elements, i.e., those game elements outside the matching subset. The separation of the matching subset from the remainder of the game outcome could occur in any fashion including, for example, separation in time, position, or both time and position.

For example, in one optional embodiment, the game elements of the matching subset are separated from the game elements outside the matching subset in time. In one such optional embodiment the game elements of the matching subset, if any, are displayed first. After the matching subset is displayed at the display, any remaining game elements within the game outcome, but outside the matching subset, are displayed.

In another example, the game elements of the matching subset are separated from the game elements outside the matching subset in position. In one such optional embodiment, the game elements of the matching subset, if any, are displayed in particular positions, such as the leftmost positions in a hand. Any remaining game elements within the game outcome, but outside the matching subset, are displayed in the rightmost positions in a hand. As may be appreciated, the positions may be different in an alternate optional embodiment.

In yet another example, the game elements of the matching subset are separated from the game elements outside the matching subset in both time and position. In one such optional embodiment, the game elements of the matching subset, if any, are displayed first. Moreover, the game elements of the matching subset are displayed in particular positions, such as the leftmost positions in a hand. Any remaining game elements within the game outcome, but outside the matching subset, are displayed after the matching subset in the rightmost positions in a hand.

In an optional embodiment, the game elements are hands of playing cords, with the hands generating separate game outcomes. In one such optional embodiment, reordering includes determining whether a subset of the hands comprises winning game outcomes and displaying the subset of hands comprising winning game outcomes before displaying the hands not comprising winning game outcomes. As may be appreciated, such an optional embodiment may likewise be conducted when the game elements are pay line combinations of slot reel symbols.

In an optional embodiment, the present invention may include a gaining device. In one such optional embodiment, a gaming device may include a data processor, a display in communication with the data processor, and a data storage device in communication with the data processor.

The data storage device stores program instructions executable by the data processor to conduct the wagering game to generate a game outcome including a plurality of game elements, a schedule of winning game outcomes and associated payouts, and program instructions executable by the data processor to conduct a method according to an embodiment of the present invention.

In one such optional embodiment, at least one wager is received at the gaming device. The wagering game is conducted to generate a game outcome. The game outcome is compared to the schedule of winning game outcomes by the data processor. When the game outcome matches at least one of the winning game outcomes, the wager(s) are resolved by displaying the game outcome at the display and issuing a payout by the data processor based on the schedule of winning game outcomes.

Conversely, when the game outcome does not match at least one of the winning game outcomes, the wager(s) are resolved by reordering the game outcome, without altering the game outcome and collecting, the wager. In one such optional embodiment, the reordering includes a determination by the data processor whether a subset of the game elements within the game outcome partially matches at least one of the winning game outcomes. The matching subset is displayed at the display separated in time, position, or time and position from any remaining game elements outside the matching subset.

For example, in one optional embodiment, game elements within the matching subset are displayed first, in the leftmost positions in a hand. After the matching subset is displayed, any remaining game elements that are within the game outcome, but outside the matching subset, are displayed in the rightmost positions in a hand. As may be appreciated, the matching subset and the game elements outside the matching subset may be separated only in time or position as previously described. For example, in an optional embodiment, the matching subset and remaining game elements are displayed together at the display, but with the game elements of the matching subset occupying the leftmost positions in a hand, and the game elements outside the matching subset occupying the rightmost positions in a hand (or vice versa).

### BRIEF DESCRIPTION OF THE DRAWINGS

FIG. 1 is a flow chart of a method according to an embodiment of the present invention;

FIG. 2 is a block diagram of a device according to an embodiment of the present invention:

FIG. 3 is a block diagram of an example game conducted according to an embodiment of the present invention;

FIG. 4 is a block diagram of an example game conducted according to an embodiment of the present invention.

### DESCRIPTION

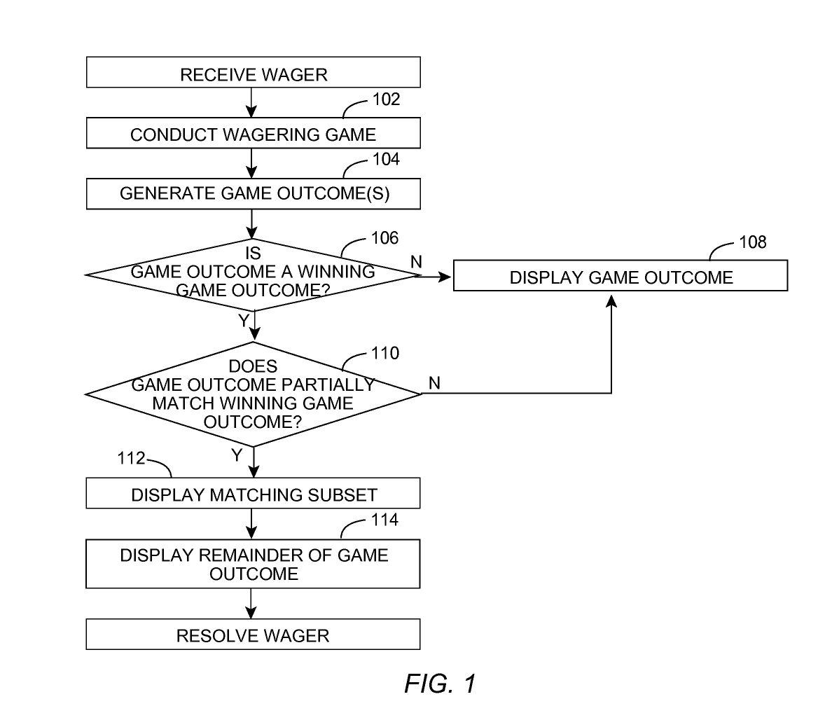

Reference is now made to the figures wherein like parts are referred to by like numerals throughout. With general reference to FIGS. 1-4, the present invention includes a method and device for displaying the outcome of a wagering game. It should be noted that the present invention is not necessarily tied to a change in either the conduct of a wagering game or the outcome that may result from a wagering game. Rather, in its narrowest application, the present invention is limited to an alteration to the display of a conventionally generated outcome in a conventionally conducted wagering game. However, it is noted that the present invention may be paired with any game, whether the game is, or is based on, a conventional game, or the game is novel.

In this regard, the present invention contemplates application to a wagering game in which a game outcome is generated. In an optional embodiment, the game outcome is generated via a random outcome generator, such as an electronic random number generator, playing card shuffler, ball blower, physical dice, physical tiles, physical wheel, physical reel, or the like.

The game outcome includes a plurality of game elements. The game elements may take any form depending on the game. For example, game elements may include playing cards (or playing card faces), slot reel symbols, tiles (or tile faces), dice or dice faces), numbers, or the like. As noted above, in an optional embodiment in which the game outcome is generated a random number generator, the game outcome may include one or more game elements mapped to a random number capable of being generated by the random number generator. Thus, when a random number is generated by a random number generator, a data processor (described in greater detail below) may translate the random number to a game outcome based on the game element or combination of game elements mapped to the random number generated.

In an optional embodiment. a method may be conducted on a gaining device. A gaming device may take any form, including a mechanical or electro-mechanical slot machine, electronic gaming machine, video lottery terminal, electronic table system handheld device, mobile phone, tablet, personal computer, kiosk, game console, or the like. When referring to a gaming device, it is contemplated that the game may use real-money credits or fictional credits. Similarly, in an optional embodiment using fictional credits, fictional credits may be provided for free, may be purchased, or a combination thereof. Additionally, it is contemplated that the method may be conducted local to the gaming device, remote from the gaining device (such as at a server), or a combination thereof.

In an optional embodiment, a gaming device includes a data processor 200. A data processor 200 may take any form, including a semiconductor microprocessor or other computing device. In an optional embodiment, a data processor 200 incorporates, cooperates with, or executes a random number generator. The random number generator may take any form, including software, hardware, or firmware.

The data processor 200 communicates with a display 202. The display 202 may take any form, including a cathode ray tube (“CRT”) monitor, plasma screen, liquid crystal display (“LCD”), light emitting diode (“LED”) display, organic light emitting diode (“OLED”) display, or the like. The data processor 200 may communicate directly with the display 202 or may communicate via an intermediary device, such as a video card, video controller, or the like.

In an optional embodiment, the data processor 200 may communicate with a player interface 204. In such an optional embodiment, the player interface 204 may receive input and/or deliver output. Consequently, the player interface 204 may incorporate many different devices, such as a button panel, keypad, keyboard, mouse, pointer, coin receiver, bill/ticket reader, ticket dispenser, or the like. In an optional embodiment, the player interface 204 may be incorporated into the display 202, such as in a touch screen device.

The data processor 200 communicates with a data storage device 206. The data storage device 206 may take any form, including optical storage, magnetic storage, Flash memory, or any other type of data storage. It is also noted that the data storage device 206 may be local to the gaming device or may be remote from the gaming device, such as cloud-based or server-based data storage.

In an optional embodiment, the data storage device 206 may store program instructions executable by the data processor 200 to conduct the wagering game, as well as game asset data (such as graphics, sounds, animation, pay tables defining winning game outcomes and associated payouts, or the like) used in conducting the wagering game. Additionally, the data storage device 206 may store program instructions executable by the data processor 200 to conduct a method according to an embodiment of the present invention.

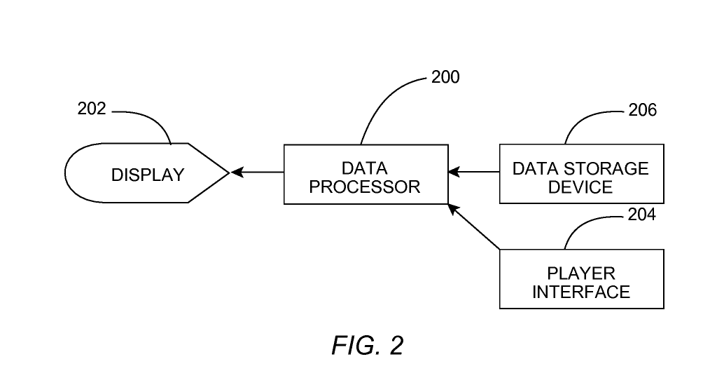

More specifically, with reference to FIGS. 1 and 2, a data processor 200 conducts 102 a wagering game. Optionally, the data processor 200 conducts the wagering game in response to receipt of a wager. As noted above, the data processor 200 may conduct the wagering game by executing program instructions stored at a data storage device 206 and utilizing game assets stored at a data storage device 206. One or more game outcomes are generated 104 by the data processor 200, optionally in cooperation with a random number generator, through conduct of the wagering game. The game outcome(s) are compared to a schedule of winning game outcomes. Optionally, the schedule of winning game outcomes, such as a pay table, is stored at e data storage device 206.

When a game outcome matches 106 a winning game outcome, the game outcome may be displayed 108 at the display 202 by the data processor 200. For example, in an optional embodiment applied to video poker, a game outcome containing a straight may be displayed at the display 202 without reordering the game outcome as described in greater detail below. Similarly, in an example embodiment applied to reel slots, a game outcome containing matching symbols on four adjacent reels along a pay line of a five-reel slot game may be displayed at the display 202 without reordering the game outcome as described in greater detail below. Likewise, in an example embodiment applied to Keno, a game outcome in which five of seven spots are “caught” may be displayed at the display 202 without reordering the game outcome as described in greater detail below.

Conversely, if the game outcome is not a winning, game outcome according to the schedule of winning game outcomes, the game outcome may be examined 110 to determine if the game outcome partially matches, i.e., contains a subset that partially matches, a winning game outcome. If the game outcome does not even partially match a winning game outcome, the game outcome may be displayed 108 at the display 202 by the data processor 200. For example, if the game outcome includes a mixed combination of reel symbols, playing cards, or the like, the game outcome may not include a subset which partially matches a winning game outcome and, as such, may be displayed at the display 202 without reordering as described below. Similarly, if the game outcome includes no Keno spots caught, the game outcome may not include a subset which partially matches a winning game outcome and, as such, may be displayed at the display 202 without reordering.

If the game outcome is not a winning game outcome, but partially matches a winning game outcome, i.e., the game outcome includes a subset that matches a subset of a winning game outcome, the game outcome may be reordered prior to displaying the game outcome at the display 202. Specifically, the reordering may include identifying the matching subset of the game outcome, i.e., the portion of the game outcome that partially matches a winning game outcome, and displaying 112 the matching subset prior to displaying 114 the remainder of the game outcome, the portion of the game outcome outside the matching subset. It is noted that the reordering occurs without altering the game outcome. That is, the game elements within the game outcome remain the same after the reordering. However, the game elements of the game outcome are displayed in a specific order in time and/or position in which the matching subset is displayed separate from the remainder of the game outcome. The wager, if any, is resolved based on the game outcome, which remains unaltered When it is reordered.

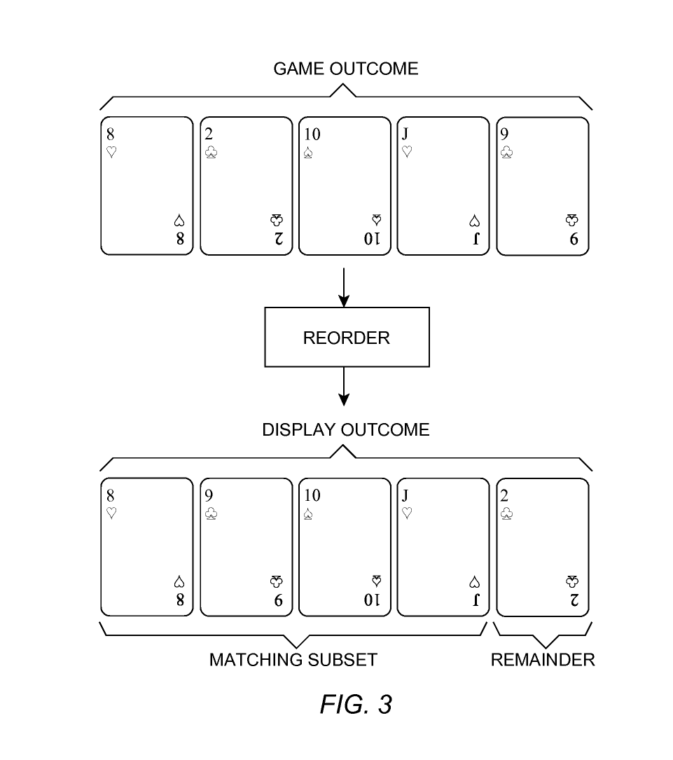

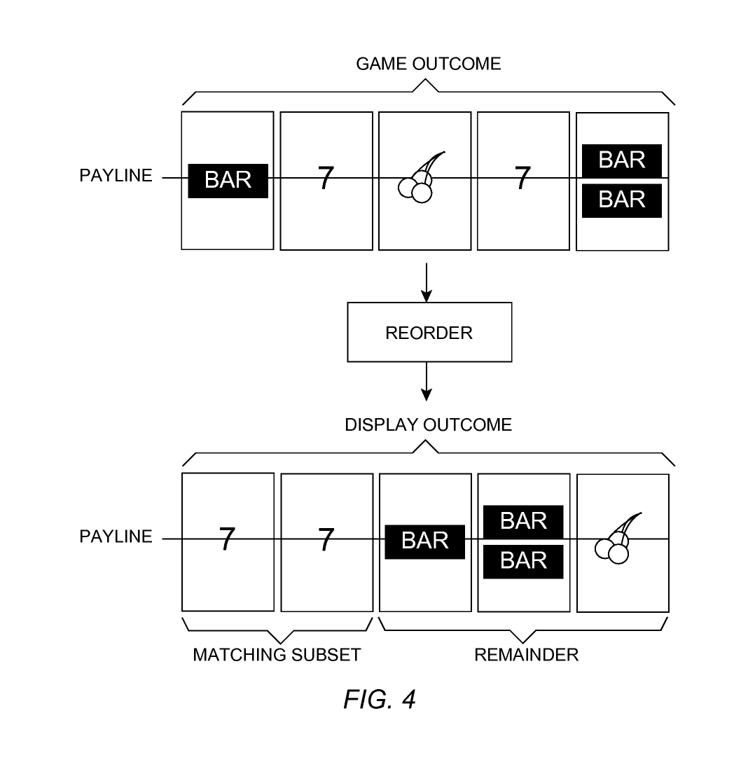

In one optional embodiment, the matching subset is separated from the remainder of the game outcome in time. In such an optional embodiment, the game elements of the matching subset are displayed first, with the remainder of the game outcome outside the matching subset displayed afterward. Thus, in the examples illustrated in FIGS. 3 and 4, the matching subset could be displayed before the remainder of the matching subset is displayed.

In another optional embodiment, the matching subset is separated from the remainder of the game outcome in position. For example, in one such optional embodiment, the matching subset may be displayed in a particular position on a display and the remainder of the game outcome may be displayed in a separate position on a display. Thus, in the examples illustrated in FIGS. 3 and 4, the matching subset is displayed in the leftmost positions and the remainder of the matching subset is displayed in the rightmost positions. It should be noted that FIGS. 3 and 4 are merely illustrative, and not limiting, since the matching subset could be displayed in any position on a display.

In yet another optional embodiment, the matching subset is separated from the remainder of the game outcome in both time and position. For example, in one such optional embodiment, the matching subset may be displayed first in a particular position, followed by the remainder of the game outcome displayed in a separate position. Thus, in the examples illustrated in FIGS. 3 and 4, the matching subset may be displayed first in the leftmost positions, followed by the remainder of the game outcome displayed in the rightmost positions. Again, FIGS. 3 and 4 should be interpreted as merely illustrative, and not limiting, since the matching subset could be displayed in any position on a display.

More specifically, in one optional embodiment applied to video poker as illustrated in FIG. 3, a game outcome that includes a busted straight, e.g., a subset of sequential playing cards in a hand with at least one non-sequential playing card, the subset that matches a straight winning outcome may be displayed before the non-suited playing card(s). Thus, in one such example, a hand containing 8♡ 2 [symbol] 10 [symbol] J♡ [symbol] may be reorder to display 8♡ 9 [symbol] 10 [symbol] J♡ before displaying 2 [symbol] , so that the reordered game outcome appears as 8♡ [symbol] 10 [symbol] J♡ 2 [symbol] . It is contemplated that such a reordered display, particularly when it is revealed in stages, may give the impression to a player that the game outcome was close to a winning game outcome, thereby generating suspense and excitement. As discussed above, the game outcome is exactly the same, but the game elements are reordered to display a subset that partially matches a winning game outcome before displaying the remainder of the game outcome, i.e., the game elements within the game outcome but outside the matching subset. Although the example of FIG. 3 illustrates rearranging the positions of the playing cards, it is also contemplated that the playing cards may remain in their dealt positions, while changing the sequence in which the playing cards are displayed. Thus, in an alternate optional embodiment, the game outcome may be revealed in a reordered sequence, with the 8♡ displayed first, then the 9 [symbol] in the fifth position, displayed second, then the 10 [symbol] in the third position, displayed third, and so forth. Thus, reordering may apply to both the position and sequence in which the game elements of the game outcome are displayed, or reordering may only apply to the sequence in which game elements of the game outcome are displayed while the positions remain fixed.

Similarly, in an optional embodiment applied to reel slot games as illustrated in FIG. 4, matching symbols may be reordered prior to display. For example, an outcome of “BAR” “7” “CHERRY” “7” “DOUBLE BAR” may be reordered so that the matching symbols are displayed together, e.g., “7” “7” “BAR” “DOUBLE BAR” “CHERRY”. Again, the game outcome remains the same, but the reel symbols may be reordered for purpose of displaying the game outcome at the display 202. Again, the step of reordering may apply to both the positions and the sequence, or merely the sequence. Thus, in an alternate example of FIG. 4, the second and fourth reels containing the “7” symbols may stop first, then the first, third, and fifth reels stop afterward.

In an example applied to Keno, spots that are caught may be displayed prior to spots that are not caught. For example, if a player set includes the numbers 3 5 10 22 40 73 75, and the player catches the numbers 10 22 and 73, the game outcome may be displayed at the display 202 by showing the numbers 10 22 and 73 (although not necessarily in that order) which were caught, then displaying the “non-catches” 3 5 40 and 75 (although not necessarily in that order) after the matching subset is displayed.

It is contemplated that the threshold for reordering may vary depending on the optional embodiment. For example, in video poker, three of a kind partially matches four of a kind and a pair partially matches three of a kind. it is contemplated that, for example, hands that are winning game outcomes may still be subject to reordering when they also form a subset of another winning game outcome. Other examples could include such hands as a straight which includes a subset that matches a straight flush, two pair which is a subset Of a full house, a straight or straight flush which includes a subset that matches a royal flush, and the like.

In an optional embodiment, the game may include multiple, independent game outcomes. For example, in various optional embodiments, game elements may be hands of playing cards (e.g.,. multi-hand poker, multi-hand blackjack, or the like), pay line combinations of reel slot symbols, or the like. In such an optional embodiment, each game element generates a separate game outcome. Thus, in the example of a multi-hand poker game, the final outcome of each hand is independently evaluated. Similarly, in a reel slot game with multiple pay lines, the symbol combination along each pay line is independently evaluated.

In one such optional embodiment, the game elements (e.g., the separately evaluated hands, pay line combinations, etc.) may be reordered in addition to, or in place of, the individual components of the game elements. As above, winning and/or near-winning game elements may be displayed first, and non-winning (e.g., losing) hands are displayed last.

That is, in an optional embodiment directed to multi-hand poker, the multiple hands may be reordered with winning hands and near-winning hands shown first, and losing hands shown last. At the same time, the individual playing cards making up each hand may (or may not) be reordered as well. Thus, in an optional embodiment in which the playing cards in each hand are reordered, near-winning hands may be displayed with the subset of the winning combination shown first (as described in greater detail above) and the remaining playing cards shown last.

Similarly, in an example directed to a reel slot game, a subset of the pay line combinations that make up winning and/or near-winning pay line combinations may be displayed first. After the winning and/or near-winning pay line combinations are shown, the non-winning (e.g., losing) pay line combinations may be displayed.

While certain embodiments of the present invention have been shown and described it is to be understood that the present invention is subject to many modifications and changes without departing from the spirit and scope of the claims presented herein.

I claim:

1. A method for displaying the results of a wagering game on a gaming device having a data processor, a display in communication with said data processor, and data storage device in communication with said data processor, wherein said data storage device stores program instructions executable by said data processor to conduct said wagering game to generate at least one game outcome including a plurality of game elements, a schedule of winning game outcomes, and program instructions executable by said data processor to conduct a method comprising the steps of:
conducting said wagering game to generate at lease one game outcome;
comparing said at least one game outcome to said schedule of winning game outcomes by said data processor;
displaying said at least one game outcome at said display when said at least one game outcome matches at least one of said winning game outcomes; and
reordering said at least one game outcome, without altering said at least one game outcome, When said at least one game outcome does not match at least one of said winning game outcomes, wherein said reordering comprises:
determining by said data processor whether a subset of said game elements within said at least one game outcome partially matches at least one of said winning game outcomes;
displaying at said display said matching subset; and
displaying at said display any remaining game elements within said at least one game outcome, but outside said matching subset, separate from said matching subset in at least one of time or position.

2. The method of claim 1 further comprising issuing a payout by said data processor based on said schedule of winning game outcomes when said at least one game outcome matches at least one of said winning game outcomes.

3. The method of claim 1 further comprising collecting said wager when said at least one game outcome does not match at least one of said winning game outcomes.

4. The method of claim 1 wherein said game elements are slot reel symbols.

5. The method of claim 1 wherein said game elements are playing cards.

6. The method of claim 1 wherein said game elements are numbers.

7. The method of claim 1 wherein said game elements are hands of playing cards, with said hands generating separate game outcomes, such that said step of reordering includes determining whether a subset of said hands comprises winning game outcomes and displaying said subset of hands comprising winning game outcomes before displaying said hands not comprising winning game outcomes.

8. The method of claim 1 wherein said game elements are pay line combinations of slot reel symbols, with said pay line combinations generating separate game outcomes, such that said step of reordering includes determining whether a subset of said pay line combinations comprises winning game outcomes and displaying said subset of pay line combinations comprising winning game outcomes before displaying said pay line combinations not comprising winning game outcomes.

9. A method for displaying the results of a wagering game on a gaming device haying a data processor, a display in communication with said data processor, and a data storage device in communication with said data processor, wherein said data storage device stores program instructions executable by said data processor to conduct said wagering game to generate at least one game outcome including a plurality of game elements, a schedule of winning game outcomes, and program instructions executable by said data processor to conduct a method comprising the steps of:
receiving at least one wager at said gaming device;
conducting said wagering game to generate at least one game outcome;
comparing said at least one game outcome to said schedule of winning game outcomes by said data processor;
when said at least one game outcome matches at least one of said winning game outcomes, resolving said at least one wager comprising:
displaying said at least one game outcome at said display; and
issuing a payout by said data processor based on said schedule of winning game outcomes; and
when said at least one game outcome does not match at least one of said winning game outcomes, resolving said at least one wager comprising:
reordering said at least one game outcome, without altering said at least one game outcome, wherein said reordering comprises:
determining said data processor whether a subset of said game elements within said at least one game outcome partially matches at least one of said winning game outcomes;
displaying at said display said matching subset: and
displaying at said display any remaining game elements within said at least one game outcome, but outside said matching subset, separate from said matching subset in at least one of time or position; and
collecting said wager.

10. The method of claim 9 wherein said game elements are slot reel symbols.

11. The method of claim 9 wherein said game. elements are playing cards.

12. The method of claim 9 wherein said game elements are numbers.

13. The method of claim 9 wherein said game elements are hands of playing cards, with said hands generating separate game outcomes, such that said step of reordering includes determining whether a subset of said hands comprises winning game outcomes and displaying said subset of hands comprising winning game outcomes before displaying said hands not comprising winning game outcomes.

14. The method of claim 9 wherein said game elements are pay line combinations of slot reel symbols, with said pay line combinations generating separate game outcomes, such that said step of reordering includes determining whether a subset of said pay line combinations comprises winning game outcomes and displaying said subset of pay line combinations comprising winning game outcomes before displaying said pay line combinations not comprising winning game outcomes.

15. A gaming device comprising:
a data processor;
a display in communication with said data processor; and
a data storage device in communication with said data processor, wherein said data storage device stores program instructions executable by said data processor to conduct said wagering game to generate at least one game outcome including a plurality of game elements, a schedule of winning game outcomes and associated payouts, and program instructions executable by said data processor to conduct a method comprising the steps of
receiving at least one wager at said gaming device;
conducting said wagering game to generate at least one game outcome;
comparing said at least one game outcome to said schedule of winning game outcomes by said data processor;
when said at least one game outcome matches at least one of said winning game outcomes, resolving said at least one wager comprising:
displaying said at least one game outcome at said display; and
issuing a payout by said data processor based on said schedule of winning game outcomes; and
when said at least one game outcome does not match at least one of said winning game outcomes, resolving said at least one wager comprising:
reordering said at least one game outcome, without altering said at least one game outcome, wherein said reordering comprises:
determining by said data processor whether a subset of said game elements within said at least one game outcome partially matches at least one of said winning game outcomes;
displaying at said display said matching subset; and
displaying at said display any remaining game elements within said at least one game outcome, but outside said matching subset, separate from said matching subset in at least one of time or position.

16. The gaming device of claim 15 wherein said game elements are slot reel symbols.

17. The gaming device of claim 15 wherein said game elements are playing cards.

18. The gaming device of claim 15 wherein said game elements are numbers.

19. The gaming device of claim 15 wherein said game elements are hands of playing cards, with said hands generating separate game outcomes, such that said step of reordering includes determining whether a subset of said hands comprises winning game outcomes and displaying said subset of hands comprising winning game outcomes before displaying said hands not comprising winning game outcomes.

20. The gaming device of claim 15 wherein said game elements are pay line combinations of slot reel symbols, with said pay line combinations generating separate game outcomes, such that said step of reordering includes determining whether a subset of said pay line combinations comprises winning game outcomes and displaying said subset of pay line combinations comprising winning game outcomes before displaying said pay line combinations not comprising winning game outcomes.
